(19) United States
(12) Patent Application Publication
(10) Pub. No.: US 2019/0342289 A1
(43) Pub. Date: Nov. 7, 2019

(54) Network Authentication Method and Apparatus

(71) Applicant: Alibaba Group Holding Limited, Grand Cayman (KY)

(72) Inventors: Bijun Zhu, Zhejiang (CN); Hao Yang, Zhejiang (CN); Jiankang Sun, Zhejiang (CN)

(73) Assignee: Alibaba Group Holding Limited

(21) Appl. No.: 16/516,186

(22) Filed: Jul. 18, 2019

Related U.S. Application Data
(63) Continuation of application No. PCT/CN2018/071707, filed on Jan. 8, 2018.

(30) Foreign Application Priority Data
Jan. 19, 2017 (CN) 201710039832.8

(51) Int. Cl. H04L 29/06; H04W 12/06; H04W 12/08

(52) U.S. Cl. CPC H04L 63/0876; H04L 63/108; H04L 63/0884; H04W 12/08; H04L 63/107; H04W 12/06; H04L 63/104

(57) ABSTRACT

Network authentication method and apparatus are provided. The method may include: receiving, by a server of a preset mobile enterprise work platform, an authentication request sent by a network device, the authentication request including a unique device identifier of a user device; determining, by the server, an authentication result of the unique device identifier of the user device, based on a preset group having a binding relationship with the network device, a mapping relationship between identity information of associated users of the preset group and unique device identifiers that is pre-recorded in the server, and a respective network access permission corresponding to each piece of identity information; and returning, by the server, the authentication result to the network device, to instruct the network device to control a network access operation of the user device according to the authentication result, thus simplifying a process of network authentication of the user device.

### CROSS REFERENCE TO RELATED PATENT APPLICATIONS

This application claims priority to and is a continuation of PCT Patent Application No. PCT/CN2018/071707 filed on 8 Jan. 2018, and is related to and claims priority to Chinese Patent Application No. 201710039832.8, filed on 19 Jan. 2017 and entitled “Network Authentication Method and Apparatus,” which are hereby incorporated by reference in their entirety.

### TECHNICAL FIELD

The present disclosure relates to the technical field of network authentication, and particularly to network authentication methods and apparatuses.

### BACKGROUND

When a user wants to connect a user device to a wireless network, the user device is first connected to a network device such as an AP (a wireless access point), and then achieves a network access through the network device. A network access operation is actually an access operation to the Ethernet, and the network device is equivalent to a bridge between the wireless network and the Ethernet.

In related technologies, wireless networks comply with the IEEE 802.1x standard to provide access control and authentication. An enterprise scenario is used as an example. Since high information security requirements are involved, an EAP-TLS (Extensible Authentication Protocol-Transport Layer Security) protocol such as the IEEE 802.1x standard can be used to perform network authentication on a user device that accesses a network device.

However, a PKI (Public Key Infrastructure) system needs to be deployed in an enterprise in a process of authentication of the related technologies, and the PKI system is very large and complex, with very high initial investment and post-maintenance requirements. Furthermore, based on the deployed PKI system, a digital certificate needs to be stored individually on a user device and a server, and the validity of the digital certificate needs to be maintained periodically. Moreover, in the process of authentication, two parties need to perform mutual authentication on the digital certificate, which causes the process of authentication to be complicated and have a low efficiency.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

In view of the above, the present disclosure provides a method and an apparatus for network authentication, which can simplify a process of network authentication for a user device.

To achieve the above objectives, the present disclosure provides the following technical solutions.

In implementations, a network authentication method is provided, which includes:

receiving, by a server of a preset instant messaging application, an authentication request sent by a network device, the authentication request including a unique device identifier of a user device;

determining, by the server, an authentication result of the unique device identifier of the user device, based on a preset group having a binding relationship with the network device, a mapping relationship between identity information of associated users of the preset group and unique device identifiers that is pre-recorded in the server, and a respective network access permission corresponding to each piece of identity information; and

returning, by the server, the authentication result to the network device, to instruct the network device to control a network access operation of the user device according to the authentication result.

In implementations, a network authentication method is provided, which includes:

obtaining, by a network device client running on a network device that is bound to a preset group, a unique device identifier of a user device in response to the network device detecting an access of the user device;

sending, by the network device client, an authentication request including the unique device identifier of the user device to a server of a preset instant messaging application, wherein the authentication request is used for instructing the server to perform authentication on the unique device identifier of the user device preset based on a pre-stored mapping relationship between identity information of associated users of the preset group and unique device identifiers, and a respective network access permission corresponding to each piece of identity information; and

receiving, by the network device client, an authentication result of the unique device identifier of the user device returned by the server, and controlling a network access operation of the user device according to the authentication result.

In implementations, a network authentication method is provided, which includes:

determining, by a user client of a preset instant messaging application running on an electronic device, identity information of a logged-in user; and

sending, by the user client, a notification message to a server of the instant messaging application, wherein the notification message includes the identity information and a unique device identifier of the electronic device, to cause the server to record a mapping relationship between the identity information and the electronic device, wherein the mapping relationship is used for instructing the server to apply a network access permission of the identity information in a preset group to the electronic device to control the electronic device to implement a network access operation based on network device(s) under the preset group.

In implementations, a network authentication apparatus is provided, which includes:

a request receiving unit that causes a server of a preset instant messaging application to receive an authentication request sent by a network device, the authentication request including a unique device identifier of a user device;

an authentication unit that causes the server to determine an authentication result of the unique device identifier of the user device, based on preset groups having a binding relationship with the network device, a mapping relationship between identity information of associated users of the preset groups and unique device identifiers that is pre-recorded in the server, and a respective network access permission corresponding to each piece of identity information; and

a returning unit that causes the server to return the authentication result to the network device, to instruct the network device to control a network access operation of the user device according to the authentication result.

In implementations, a network authentication apparatus is provided, which includes:

an acquisition unit that causes a network device client running on a network device that is bound to a preset group to obtain a unique device identifier of a user device in response to the network device detecting an access of the user device;

a sending unit that causes the network device client to send an authentication request including the unique device identifier of the user device to a server of a preset instant messaging application, wherein the authentication request is used for instructing the server to perform authentication on the unique device identifier of the user device preset based on a pre-stored mapping relationship between identity information of associated users of the preset group and unique device identifiers, and a respective network access permission corresponding to each piece of identity information; and

a control unit that causes the network device client to receive an authentication result of the unique device identifier of the user device returned by the server, and control a network access operation of the user device according to the authentication result.

In implementations, a network authentication apparatus is provided, which includes:

a determination unit that causes a user client of a preset instant messaging application running on an electronic device to determine identity information of a logged-in user; and

a sending unit that causes the user client to send a notification message to a server of the instant messaging application, wherein the notification message includes the identity information and a unique device identifier of the electronic device, to cause the server to record a mapping relationship between the identity information and the electronic device, wherein the mapping relationship is used for instructing the server to apply a network access permission of the identity information in a preset group to the electronic device to control the electronic device to implement a network access operation based on network device(s) under the preset group.

As can be seen from the above technical solutions, through a mapping relationship between identity information and device MAC addresses that is pre-stored on a server, the present disclosure only needs a network device to obtain a MAC address of a user device in order to enable the server to perform authentication according to the pre-stored mapping relationship. This can not only simplify a process of authentication of the user device by the server and improve the efficiency of authentication of the user device, but can also avoid deploying a PKI system and reduce investment and complexity of an entire system.

### BRIEF DESCRIPTION OF THE DRAWINGS

FIG. 1 is a flowchart of a network authentication method based on a server side according to an exemplary embodiment of the present disclosure.

FIG. 2 is a flowchart of a network authentication method based on a network device client side according to an exemplary embodiment of the present disclosure.

FIG. 3 is a flowchart of a network authentication method based on a user client side according to an exemplary embodiment of the present disclosure.

FIG. 4 is a schematic diagram of a scenario of an application network device according to an exemplary embodiment of the present disclosure.

FIG. 5 is a flowchart of a network authentication method according to an exemplary embodiment of the present disclosure.

FIG. 6 is a flowchart of another network authentication method according to an exemplary embodiment of the present disclosure.

FIG. 7 is a schematic structural diagram of an electronic device based on a server side according to an exemplary embodiment of the present disclosure.

FIG. 8 is a block diagram of a network authentication apparatus based on a server side according to an exemplary embodiment of the present disclosure.

FIG. 9 is a schematic structural diagram of an electronic device based on a network device client side according to an exemplary embodiment of the present disclosure.

FIG. 10 is a block diagram of a network authentication apparatus based on a network device client side according to an exemplary embodiment of the present disclosure.

FIG. 11 is a schematic structural diagram of an electronic device based on a user client side according to an exemplary embodiment of the present disclosure.

FIG. 12 is a block diagram of a network authentication device based on a user client side according to an exemplary embodiment of the present disclosure.

### DETAILED DESCRIPTION

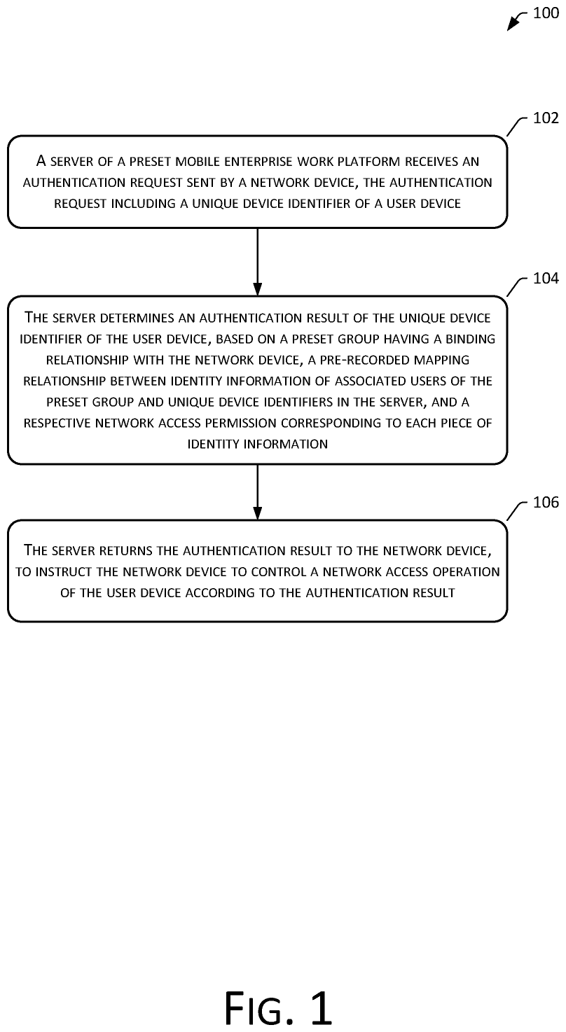

FIG. 1 is a flowchart of a network authentication method 100 based on a server side according to an exemplary embodiment of the present disclosure. As shown in FIG. 1, the method 100 is applied to a server, and may include the following operations.

Operation 102: A server of a preset mobile enterprise work platform receives an authentication request sent by a network device, the authentication request including a unique device identifier of a user device.

In implementations, a mobile enterprise work platform can not only realize a communication function, but can also be used as an integrated function platform for a number of other functions. Examples include processing internal events of an enterprise, such as examination and approval events (such as leave, office item application, financial and other examination and approval events), attendance events, task events, log events, etc., and processing of external events, such as ordering and purchasing, which are not limited in the present disclosure.

More specifically, mobile enterprise work platforms can be hosted in instant messaging applications in related technologies, for example, enterprise instant messaging (EIM) applications, such as Skype For Business®, Microsoft Teams®, Yammer®, Workplace®, Slack®, Enterprise WeChat®, Fxiaoke®, Enterprise Feixin®, Enterprise Yixin®, etc. Apparently, an instant messaging function is only one of a number of communication functions supported by the mobile enterprise work platform. The enterprise work platform can also implement more such as other functions as described above, which are not redundantly described herein.

In implementations, a unique device identifier can uniquely indicate and determine a corresponding user device, i.e., the unique device identifier has a one-to-one correspondence relationship with the user device. All pieces of identification information having a property of uniqueness can be used as a unique device identifier, which is not limited in the present disclosure. For example, the unique device identifier may be a MAC (Media Access Control) address, a serial number of the user device, etc.

Operation 104: The server determines an authentication result of the unique device identifier of the user device, based on a preset group having a binding relationship with the network device, a pre-recorded mapping relationship between identity information of associated users of the preset group and unique device identifiers in the server, and a respective network access permission corresponding to each piece of identity information.

In implementations, since the network device can only cover a certain range near a location of installation thereof (i.e., only user devices within that range can access the network device), the network device is usually bound to a preset group, and is installed within a working range of the preset group(s), so that associated users of the preset group can access and perform network access operations. A “group” may refer to various organizations such as enterprises, schools, hospitals, military units, and government agencies. These forms of organizations can adopt the above-mentioned mobile enterprise work platform to implement the technical solutions of the present disclosure.

In implementations, the server pre-records a mapping relationship between each associated user of the preset group and a corresponding unique device identifier, so as to perform authentication on the unique device identifier of the user device sent by the network device according to the recorded mapping relationship at a later time. When receiving a notification message sent by an electronic device, the server records a corresponding mapping relationship between identity information logged in a user client of the mobile enterprise work platform running on the electronic device and a unique device identifier of the electronic device included in the notification message based on the identity information and the unique device identifier included in the notification message. Apparently, in other cases, a management user of the preset group may also create such mapping relationship manually, or may edit a mapping relationship that is already recorded in the server.

In implementations, an associated user of the preset group may include at least one of the following: an internal member of the preset group, an external contact of the preset group (such as an internal member of another group that has an association relationship with the preset group, e.g., such other group and the preset group have a cooperative relationship), an external visitor of the preset group, etc. Apparently, other types of associated users may also be adapted to the technical solutions of the present disclosure, which are not limited in the present disclosure.

In implementations, since multiple associated users can perform account logins using a same user device, and a same associated user can also perform an account login on multiple user devices, the server may have multiple mapping relationships corresponding to a unique device identifier of such user device at the same time. As such, the server may select a most recently recorded mapping relationship to determine an authentication result corresponding to the unique device identifier of the user device. In practice, when detecting a login activity or an access instruction to the network device from a user, the user device may send a notification message as described above to the server, so that the server updates a mapping relationship corresponding to the user device, thereby ensuring that the mapping relationship used for authentication corresponds to an associated user who is currently logged onto the user device, and avoids applying network access permission corresponding to other associated users for authentication.

Operation 106: The server returns the authentication result to the network device, to instruct the network device to control a network access operation of the user device according to the authentication result.

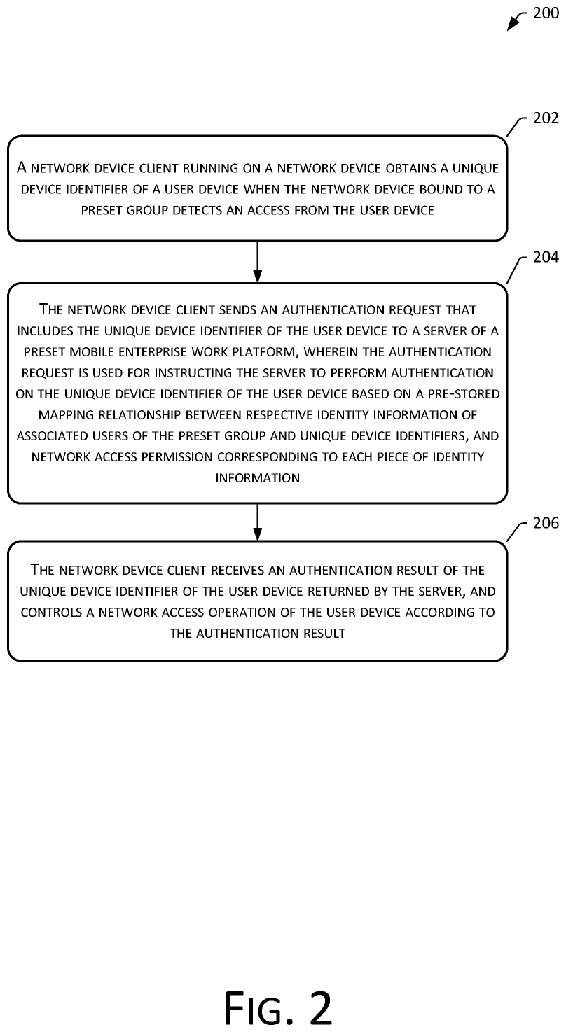

Correspondingly, FIG. 2 is a flowchart of a network authentication method 200 based on a network device client side according to an exemplary embodiment of the present disclosure. As shown in FIG. 2, the method 200 is applied to a network device client, and may include the following operations.

Operation 202: A network device client running on a network device obtains a unique device identifier of a user device when the network device bound to a preset group detects an access from the user device.

In implementations, the network device client may be a client based on a mobile enterprise work platform, or may be other client of any form, as long as the client can cooperate with a server to perform authentication and network access control on the user device, which is not limited by the present disclosure. Apparently, when the network device client is a client based on a mobile enterprise work platform, the network device client has a built-in control logic cooperated with the server, which makes implementing the technical solutions based on the present disclosure more easily.

In implementations, the network device may include any electronic device that implements a network access function, such as an AP device, which is not limited by the present disclosure.

Operation 204: The network device client sends an authentication request that includes the unique device identifier of the user device to a server of a preset mobile enterprise work platform, wherein the authentication request is used for instructing the server to perform authentication on the unique device identifier of the user device based on a pre-stored mapping relationship between respective identity information of associated users of the preset group and unique device identifiers, and network access permission corresponding to each piece of identity information.

Operation 206: The network device client receives an authentication result of the unique device identifier of the user device returned by the server, and controls a network access operation of the user device according to the authentication result.

In implementations, the network device client may control a network access operation according to a value of a permission option included in the authentication result. The permission option may include at least one of the following:

1) Is authorized? If authorized, a network access can be opened directly, or a further access control can be performed in combination with other permission options; if not authorized, the network access can be denied directly.

2) A valid period of permission: For example, when an associated user is a visitor, he/she is restricted to have network accesses within the same day only. If the valid period of permission is not past, a network access can be opened directly, or a further access control can be performed in combination with other permission options; if the valid period of permission is past, the network access can be denied directly.

3) A number of remaining usages of permission: For example, for a network permission of an temporary application, the number of remaining usages of permission may be limited to one, i.e., the user can access the network device and achieve a network access only once. After the associated user accesses the network device and implements network access, a corresponding number of remaining usages of permission is decremented by one to manage the number of remaining usages of permission. Then, when the number of remaining usages of permission is not zero, a network access can be directly opened, or a further access control can be performed in combination with other permission options. When the number of remaining usages of permission is zero, the network access can be directly denied.

4) A network range that is allowed to access: A network can be pre-divided into multiple ranges, such as an internal network of the preset group, a public network outside the preset group, a domestic range in the public network, and a foreign range in the public network, thereby performing a more detailed permission control for network access operations, which is not described exhaustively herein.

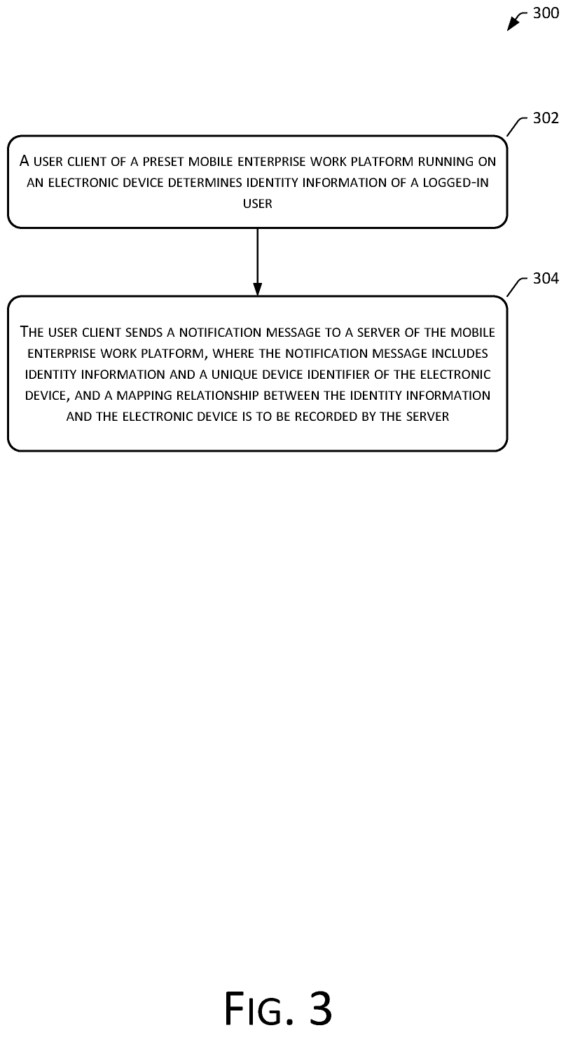

Correspondingly, FIG. 3 is a flowchart of a network authentication method 300 based on a user client side according to an exemplary embodiment of the present disclosure. As shown in FIG. 3, the method 300 is applied to a user client, and may include the following operations.

Operation 302: A user client of a preset mobile enterprise work platform running on an electronic device determines identity information of a logged-in user.

In implementations, an application program of a client of a mobile enterprise work platform can be pre-installed on an electronic device, such that the client can be launched and run on the electronic device. Apparently, when an online “client” such as HTML5 technology is used, the client can be obtained and run without the need of installing a corresponding application on the electronic device. When the network device client is a client of a mobile enterprise work platform, the above description also applies here, and details thereof are not described herein again.

Operation 304: The user client sends a notification message to a server of the mobile enterprise work platform, where the notification message includes identity information and a unique device identifier of the electronic device, and a mapping relationship between the identity information and the electronic device is to be recorded by the server.

In implementations, a mapping relationship recorded by the server corresponds to mapping relationships of the embodiments shown in FIG. 1 and FIG. 2. The mapping relationship is used for instructing the server to apply a network access permission of the identity information in a preset group to the electronic device (the electronic device can be determined based on the unique device identifier recorded in the mapping relationship), to control a network access operation performed by the electronic device based on network device(s) under the preset group.

In an embodiment, the electronic device may send a notification message as described above when the user client detects a user login activity. In this case, as long as a user account that is logged in on the electronic device changes, a mapping relationship recorded by the server may be updated according to a correspondence relationship between identity information corresponding to a currently logged-in user account and the unique device identifier of the electronic device, thereby ensuring that the server can perform authentication on the electronic device using the latest mapping relationship.

In another embodiment, the electronic device may send a notification message as described above when the user client detects an access instruction for any network device. In this case, when an account change occurs when the electronic device is not connected to the network device, a notification message may be sent when an access instruction is detected even if no notification message has been sent when a user login activity occurs. As such, the server updated a recorded mapping relationship in time to ensure that authentication is performed on the electronic device using the latest mapping relationship.

As can be seen from the above technical solutions, by pre-storing a mapping relationship between identity information and device MAC addresses in a server, a network device only needs to obtain a MAC address of a user device, and the server can perform authentication according to the pre-stored mapping relationship. This can not only simplify a process of authentication of the user device by the server and improve the efficiency of authentication of the user device, but can also avoid deploying a PKI system and reduce investment and complexity of an entire system.

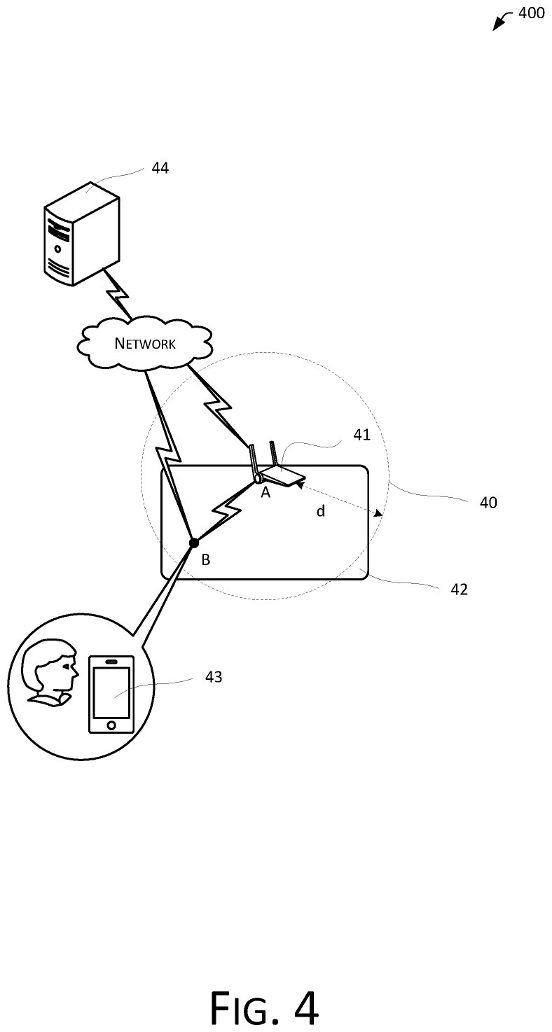

FIG. 4 is a schematic diagram of a scenario 400 of an application network device according to an exemplary embodiment of the present disclosure. As shown in FIG. 4, an AP device 41 as a network device is assumed to be installed at a point A in an office area 42 of an enterprise AA, and an AP device 41 can transmit a Beacon (beacon) frame signal within a range 40 (with the point A as the center and an emission radius d as a radius of the range), so that an electronic device in the range 40 can access the AP device 41 by scanning the Beacon frame signal. Apparently, the electronic device can adopt a way of active scanning to implement scanning and accessing to the AP device 41, which is not limited by the present disclosure. For example, when a user is located at a point B within the range 40, a mobile phone 43 used by the user can scan and access the AP device 41, and the mobile phone 43 and the AP device 41 can implement data interactions with a server 44 respectively, thereby implementing the network authentication solutions of the present disclosure.

The server 44 may be a physical server including an independent host. Alternatively, the server 44 may be a virtual server hosted by a host cluster. Alternatively, the server 44 may be a cloud server. During operations, the server 44 can run a server-side program of a certain application to implement associated service functions of the application, such as a network authentication function.

The mobile phone 43 is just one type of electronic device that can be used by a user. In fact, the user can apparently also use electronic devices such as tablet devices, notebook computers, PDAs (Personal Digital Assistants), wearable devices (such as smart glasses, smart watches, etc.), etc., which are not limited by the present disclosure. During operations, the electronic device can run a client-side program of a certain application to implement associated service functions of the application, such as a network authentication function as described above.

A network in which the mobile phone 43 (or the AP device 41) conducts interactions with the server 44 may include various types of wired or wireless networks. In an embodiment, the network may include a Public Switched Telephone Network (PSTN) and the Internet.

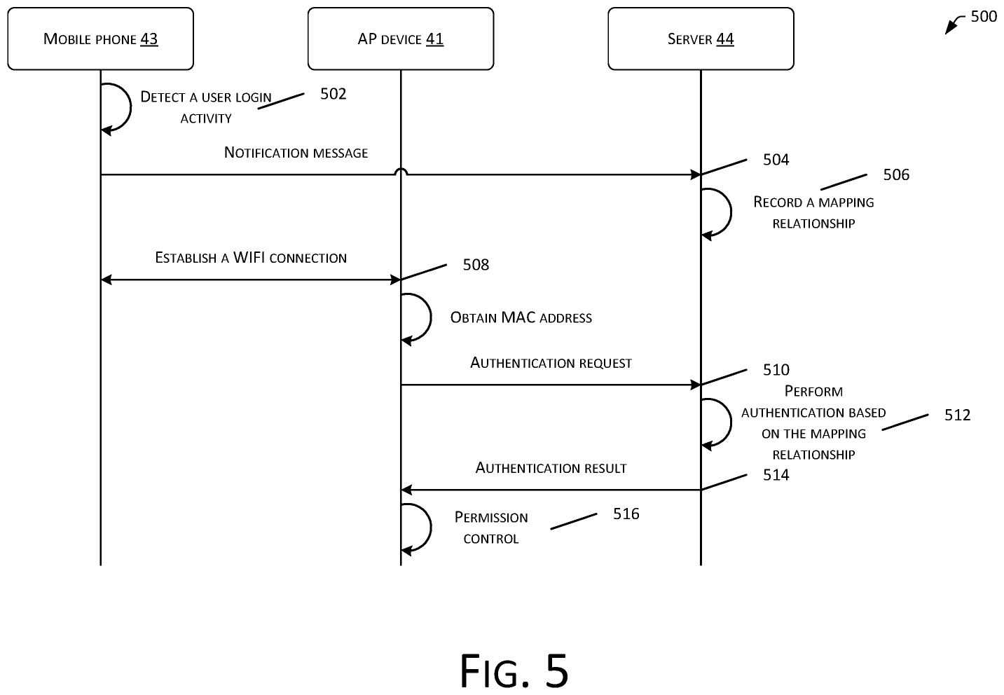

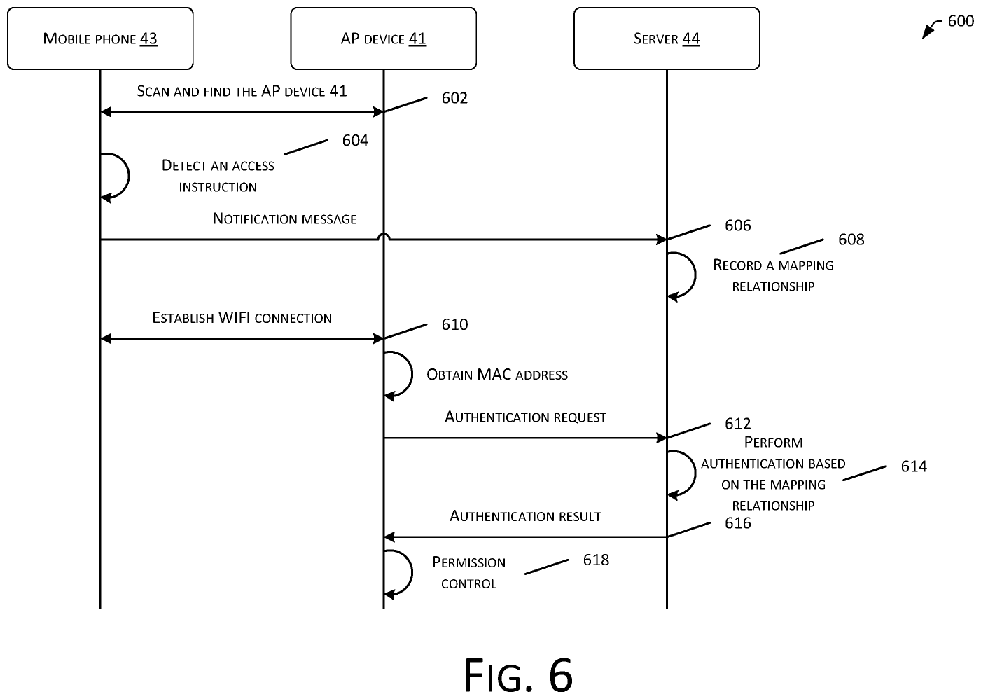

For the sake of understanding, an instant messaging application is used as an example. The mobile phone 43 and the AP device 41 are assumed to run an instant messaging client respectively, and an instant messaging server is run on the server 44. The instant messaging client is logged in with a registered account of a user on the mobile phone 43, i.e., the mobile phone 43 is configured with an instant messaging client of the user. With reference to FIGS. 5-6, the technical solutions of the present disclosure are described in detail hereinafter using a process of performing a network access by the mobile phone 43 to access the AP device 41 as an example. FIG. 5 is a flowchart of a network authentication method 500 provided by an exemplary embodiment of the present disclosure. As shown in FIG. 5, the method 500 may include the following operations.

Operation 502: The mobile phone 43 detects a user login activity.

In implementations, when a user login activity occurs, a change in user account may occur. Therefore, the instant messaging client running on the mobile phone 43 may monitor user login activities and send a notification message as described below accordingly, to ensure a timely update of a mapping relationship recorded on the instant messaging server running on the server 44.

Operation 504: The mobile phone 43 sends a notification message to the server 44, where the notification message includes identity information of a logged-in account and a MAC address of the mobile phone 43.

In implementations, the instant messaging client running on the mobile phone 43 obtains identity information of a logged-in account, and generates a notification message including the identity information. At the same time, the notification message itself includes a MAC address of the mobile phone 43 (i.e., a source MAC address), and thus the notification message includes both the identity information of the logged-in account and the MAC address of the mobile phone 43 without the need for the instant messaging client to actively add the MAC address to the notification message.

Operation 506: The server 44 records a corresponding mapping relationship according to the identity information and the MAC address included in the notification message.

In implementations, if a mapping relationship between the identity information and the MAC address included in the notification message has not been recorded in the server 44, the server 44 may create such mapping relationship. If the mapping relationship between the identity information and the MAC address included in the notification message has been recorded in the server 44, the server 44 can update a recording time of this mapping relationship.

In implementations, a same user account can be logged in on multiple electronic devices individually. Therefore, for the identity information included in the notification message, the server 44 can separately record respective mapping relationships between the identity information and multiple MAC addresses. Similarly, different user accounts can be separately logged in on a same electronic device. Therefore, for the MAC address included in the notification message, the server 44 can separately record respective mapping relationships between the MAC address and a plurality of pieces of identity information.

It should be noted that the above operations 502-506 describe a process of recording a mapping relationship by the server 44, and this process may occur at any arbitrary time before operation 512 (to ensure that this mapping relationship can be used for an operation of authentication at operation 512). Such arbitrary time is determined based on a time of detecting the user login activity at operation 502 in the embodiment as shown in FIG. 5.

Operation 508: A WIFI connection is established between the mobile phone 43 and the AP device 41.

In implementations, the mobile phone 43 can scan and detect the AP device 41 by means of active scanning or passive scanning, and access the AP device 41 based on an access instruction, so that a WIFI connection is established between the mobile phone 43 and the AP device 41.

The access instruction may be initiated by the user of the mobile phone 43. For example, the mobile phone 43 may display all AP devices that are scanned and found. When the user selects the AP device 41, the mobile phone 43 may determine that the mobile device 43 receives an access instruction for the AP device 41. The access instruction may also be automatically generated by the mobile phone 43. For example, in the previous process of accessing the AP device 41, an access operation is set to an “automatic access” mode. As such, when the mobile phone 43 subsequently scans and finds the AP device 41 without accessing other AP devices, the mobile phone 43 will automatically generate or determine that an access instruction has been generated, and automatically access the AP device 41.

Operation 510: The AP device 41 obtains the MAC address of the mobile phone 43, and sends an authentication request for the MAC address to the server 44.

Operation 512: The server 44 performs authentication on the mobile phone 43 according to a recorded mapping relationship.

In implementations, the AP device 41 is assumed to have been bounded to the enterprise AA in advance. For example, a management user of the enterprise AA performs a binding of the AP device 41 on the instant messaging, and thus the server 44 has a record of a binding relationship between the AP device 41 and the enterprise AA. Furthermore, the server 44 also has records of: mapping relationships corresponding to all associated users of the enterprise AA, and a respective network access permission of each associated user.

In one case, it is assumed that, after the server 44 receives the MAC address of the mobile phone 43, a mapping relationship that matches with the MAC address is not found, or identity information in a mapping relationship that matches with the MAC address is not an associated user of the enterprise AA. In this case, the server 44 can determine that the mobile phone 43 does not have a network access permission, i.e., an authentication result is that the authentication fails.

In another case, it is assumed that, after the server 44 receives the MAC address of the mobile phone 43, a mapping relationship that matches with the MAC address is found, and identity information recorded in the mapping relationship belongs to an associated user of the enterprise AA. As such:

If network access permissions of all associated users of the enterprise AA are the same, the server 44 can determine that the mobile phone 43 has passed the authentication and return a corresponding authentication result to the AP device 41, to cause the AP device 41 to open a network access permission of the mobile phone 43, for example, allowing the mobile phone 43 to access an external public network from within the enterprise AA.

If network access permissions of various types of associated users in the enterprise AA are different (for example, when the associated users in the enterprise AA include multiple types, such as internal members, external contacts, and external visitors, etc.), an associated user type to which identity information belongs can further be determined based on the identity information, the identity information being recorded in a mapping relationship that matches with the MAC address of the mobile phone 43. A corresponding authentication result is then returned to the AP device 41 according to a network access permission corresponding to the associated user type, so that the AP device 41 can control a network access operation of the mobile phone 43 according to the authentication result. Apparently, associated users of a same type can be further divided into multiple sub-types, such as further dividing the internal members into a management type, a research and development type, a sales type, etc. Furthermore, associated users of each sub-type can have corresponding network access permissions, and the server 44 can also send corresponding authentication results according thereto. Details thereof are not described herein again.

In implementations, the server 44 may only find a mapping relationship that matches with the MAC address of the mobile phone 43. The server 44 may directly perform authentication on the mobile phone 43 according to identity information of an associated user recorded in the mapping relationship. The server 44 may also find a plurality of mapping relationships matching with the MAC addresses of the mobile phone 43 at the same time. In this case, the server 44 may select the most recently recorded mapping relationship to perform authentication on the mobile phone 43.

The most recently recorded mapping relationship, i.e., a mapping relationship having the last editing time that is the latest. The last editing time may be a time of creation or a time of update. If the server 44 receives a notification message including identity information 1 and a MAC address 1, and creates a mapping relationship 1 between the identity information 1 and the MAC address 1 at time 1, the last editing time for the mapping relationship 1 is a time of creation, i.e., time 1. When the server 44 receives a notification message including the identity information 1 and the MAC address 1 again, the server 44 may update the last editing time of the mapping relationship 1 at time 2, and the last editing time is then changed from a time of creation to a time of update (i.e., the time at which an update operation is performed), i.e., time 2. Similarly, when the server 44 receives a notification message including the identity information 1 and the MAC address 1 again, the server 44 may update the last editing time of the mapping relationship 1 at time 3. In this case, the last editing time is changed from time 2 to a time of update (i.e., the time at which an update operation is performed), i.e., time 3.

Operation 514: The server 44 sends an authentication result to the AP device 41.

Operation 516: The AP device 41 performs a permission control on the mobile phone 43 according to the authentication result to manage a network access operation thereof.

In implementations, the authentication result may include a number of permission options, and the AP device 41 may control a network access operation of the mobile phone 43 according to respective value(s) of the permission option(s). The permission option(s) include(s) at least one of the following: whether is authorized, a valid period of permission, a number of remaining usages of permission, a network range allowed to access. Apparently, more types of permission options may be used, and the present disclosure does not have any limitations thereon.

In a relatively simple logic of permission management, the authentication result may include only “whether is authorized”. For example, a value of one means that it is authorized, and a value of zero means that it is not authorized. Therefore, the AP device 41 allows the mobile phone 43 to perform a full network access operation when the value is one, and denies the mobile phone 43 to perform any network access operation when the value is zero.

In a more complex logic of permission management, the authentication result can contain multiple permission options at the same time. For example:

When the authentication result includes both “whether it is authorized” and “network range allowed to access”, if a value of “whether it is authorized” indicates that it is authorized, and a value of “network range allowed to access” indicates an internal local area network and an external public network, the mobile phone 43 is allowed to perform network access operations on the internal local area network and the external public network. If the value of “whether it is authorized” indicates that it is authorized, and the value of “network range allowed to access” indicates an internal local area network, the mobile phone 43 is allowed to perform network access operations on the internal local area network, and is restricted from accessing the external public network. If the value of “whether it is authorized” indicates that it is not authorized, the mobile phone 43 is denied from performing any network access operations regardless what the value of “network range allowed to access” is. Other situations are not redundantly described herein.

When the authentication result includes “whether it is authorized”, “valid period of permission”, and “network range allowed to access”, if a value of “whether it is authorized” indicates that it is authorized, a value of “valid period of permission” indicates that it is not expired, and a value of “network range allowed to access” indicates an internal local area network and an external public network, the mobile phone 43 is allowed to perform network access operations on the internal local area network and the external public network. If the value of “whether it is authorized” indicates that it is authorized and the value of “valid period of permission” indicates that it is expired, the mobile phone 43 is denied from performing any network access operations regardless of what the value of “network range allowed to access” is. Other situations are not redundantly described herein.

Apparently, different modes of permission management can be implemented using a combination of any of a plurality of permission options, in order to satisfy permission management requirements in different scenarios, which are not exhaustively described herein, and are not limited by the present disclosure.

In the embodiment shown in FIG. 5, the mobile phone 43 may send a notification message to the server 44 by using a “detected user login activity” as a triggering condition, so that the server 44 can create or update a mapping relationship corresponding to the mobile phone 43. If the user account is logged in on the mobile phone 43 for the first time (logging in on the mobile phone 43 for the first time, but may have been logged in on other electronic devices), the server 44 needs to create a corresponding mapping relationship, if the user account is not logged in on the mobile phone 43 for the first time (a login operation has previously been performed on the mobile phone 43), the server 44 needs to update a corresponding mapping relationship (such as updating the last editing time thereof).

In practice, the mobile phone 43 can also send a notification message as described above to the server 44 based on other conditions, to ensure that a mapping relationship recorded on the server 44 remains updated. For example, as shown in FIG. 6, in a network authentication method 600 of another exemplary embodiment, the method 600 may include the following operations.

Operation 602: The mobile phone 43 scans and finds the AP device 41.

In implementations, the mobile phone 43 can scan and find the AP device 41 by means of active scanning or passive scanning, which is not limited in the present disclosure.

Operation 604: The mobile phone 43 detects an access instruction.

In implementations, the access instruction may be initiated by a user of the mobile phone 43. For example, the mobile phone 43 may show all AP devices that are scanned and found. When the user selects the AP device 41, the mobile phone 43 may determine that the mobile phone 43 receives an access instruction for the AP device 41. The access instruction may also be automatically generated by the mobile phone 43. For example, in a previous process of accessing the AP device 41, an access operation is set to be an “automatic access” mode. In this case, when the mobile phone 43 scans and finds the AP device 41 in a subsequent process and has not accessed other AP devices yet, the mobile phone 43 will automatically generate or determine that an access instruction has been generated and automatically access the AP device 41.

Operation 606: The mobile phone 43 sends a notification message to the server 44, the notification message including identity information of a logged-in account and a MAC address of the mobile phone 43.

In implementations, since it is desired to have the AP device 41 to manage permissions of the mobile phone 43 about network accesses in the present disclosure, if no access instruction is detected when a login of a user account occurs in the mobile phone 43, this indicates that the AP device 41 is not involved in permission management of the mobile phone 43. In this case, the mobile phone 43 does not need to send a notification message to the server 44. When the mobile phone 43 detects an access instruction, the server 44 can promptly create or update a mapping relationship corresponding to the mobile phone 43 by sending a notification message to the server 44, to ensure that the mapping relationship recorded on the server 44 is the latest data.

For subsequent operations 608-618, reference may be made to operations 506-516 in the embodiment as shown in FIG. 5, and details thereof are not described herein again.

In short, based on a mobile enterprise work platform, the present disclosure can have a mapping relationship between identity information and a device MAC address to be recorded on a server of the mobile enterprise work platform, and an authentication on a network access permission of a user device can be quickly performed according to the mapping relationship, thus effectively simplifying the complexity of a process of authentication and ensures the efficiency of authentication while ensuring the security of network data.

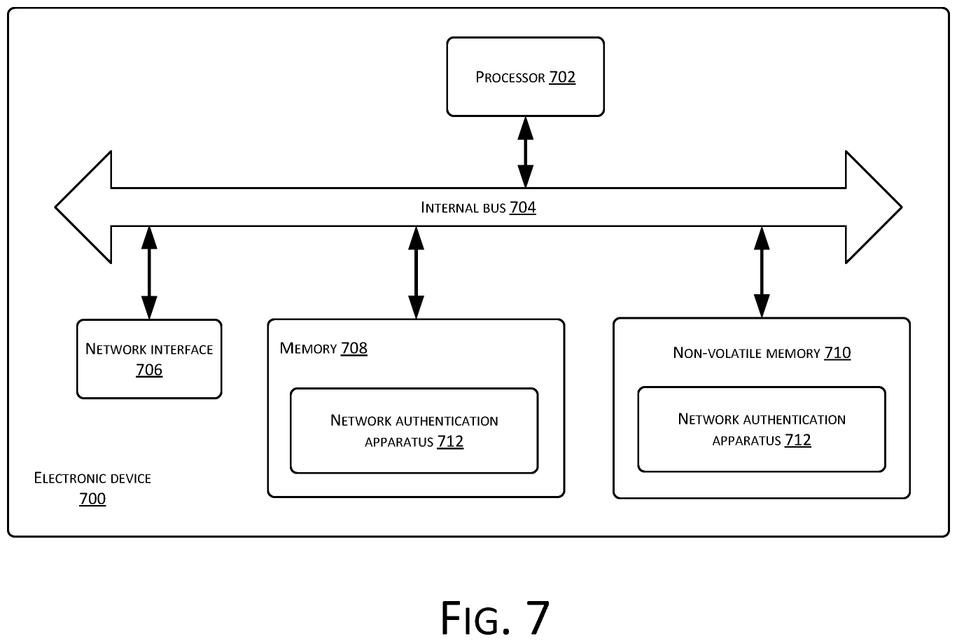

FIG. 7 shows a schematic structural diagram of an electronic device 700 according to an exemplary embodiment of the present disclosure. Referring to FIG. 7, at a hardware level, the electronic device 700 includes a processor 702, an internal bus 704, a network interface 706, a memory 708, and a non-volatile memory 710. Apparently, hardware components needed by other services may also be included. The processor 702 reads a corresponding computer program from the non-volatile memory 710 into the memory 702 and then operates to form a network authentication apparatus 712 at a logical level. Apparently, in addition to software implementations, the present disclosure does not exclude other manners of implementation, such as a logic device or a combination of software and hardware, etc. In other words, an execution body of the following flow of processing is not limited to various logical units, and may be hardware or logic device(s).

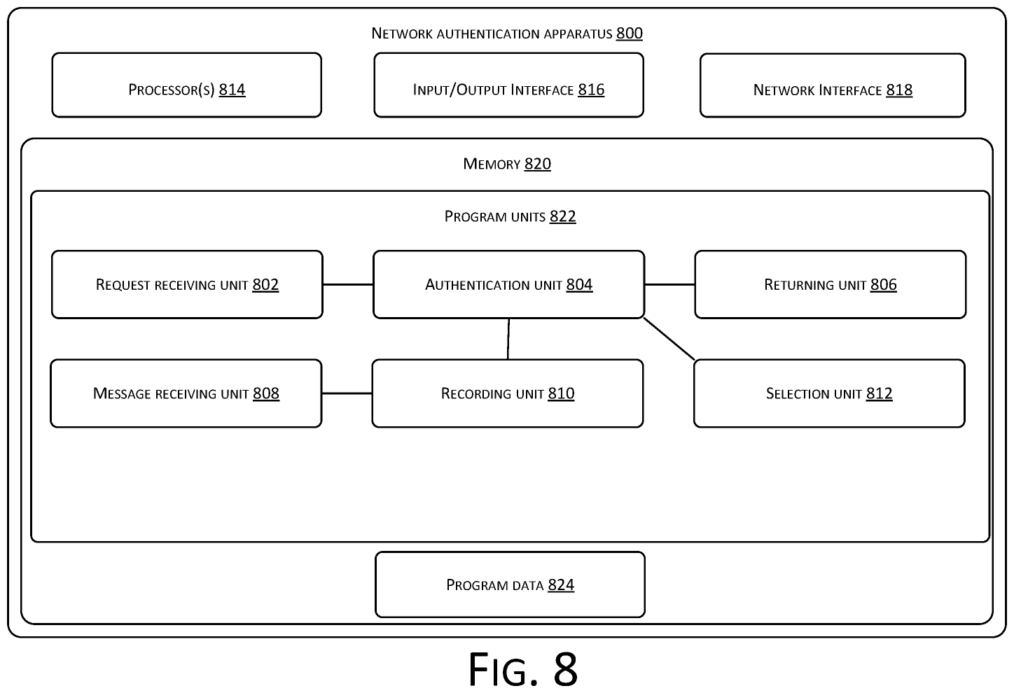

Referring to FIG. 8, in implementations, a network authentication apparatus 800 may include a request receiving unit 802, an authentication unit 804, and a returning unit 806.

The request receiving unit 802 causes a server of a preset mobile enterprise work platform to receive an authentication request sent by a network device, the authentication request including a unique device identifier of a user device.

The authentication unit 804 causes the server to determine an authentication result of the unique device identifier of the user device, based on a preset group having a binding relationship with the network device, a mapping relationship between identity information of associated user(s) of the preset group and unique device identifier(s) that is pre-recorded in the server, and a respective network access permission corresponding to each piece of identity information.

The returning unit 806 causes the server to return the authentication result to the network device, to instruct the network device to control a network access operation of the user device according to the authentication result.

In implementations, the apparatus 800 also includes:

a message receiving unit 808 that causes the server to receive a notification message sent by an electronic device, the notification message including identity information that is logged in a user client of the mobile enterprise work platform running on the electronic device, and a unique device identifier of the electronic device; and

a recording unit 810 that causes the server to record the identity information and the unique device identifier included in the notification message as a corresponding mapping relationship.

In implementations, the apparatus 800 also includes:

a selection unit 812 that causes the server to select a most recently recorded mapping relationship for determining the authentication result corresponding to the unique device identifier of the user device when multiple mapping relationships corresponding to the unique device identifier of the user device exist.

In implementations, the associated user(s) include(s) at least one of the following: an internal member of the preset group, an external contact of the preset group, and an external visitor of the preset group.

In implementations, the apparatus 800 may further include one or more processors 814, an input/output (I/O) interface 816, a network interface 818, and a memory 820.

The memory 820 may include a form of computer readable media such as a volatile memory, a random access memory (RAM) and/or a non-volatile memory, for example, a read-only memory (ROM) or a flash RAM. The memory 820 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 820 may include program units 822 and program data 824. The program units 822 may include one or more of the foregoing units as described above and as shown in FIG. 8.

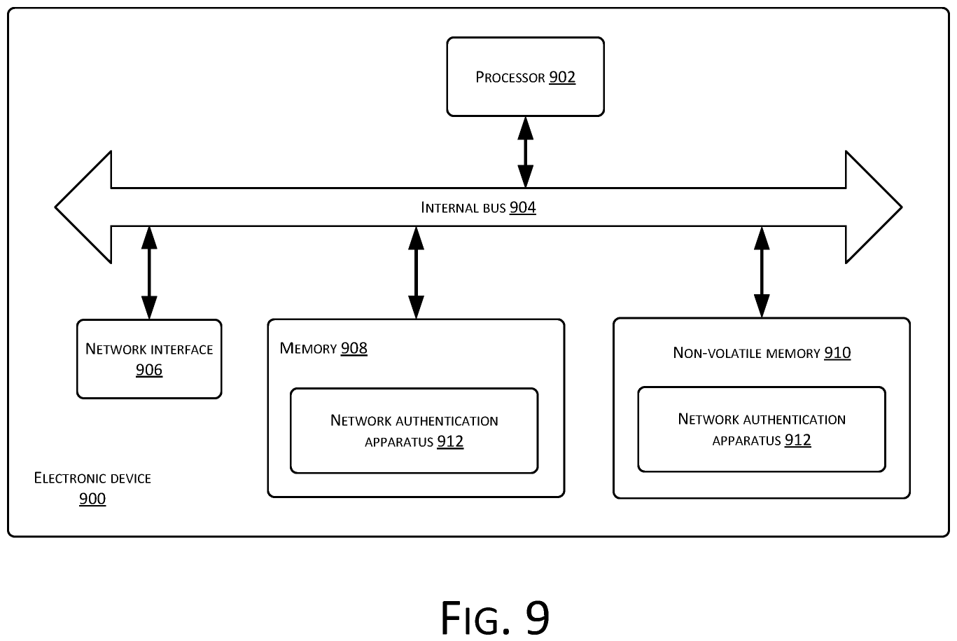

FIG. 9 shows a schematic structural diagram of an electronic device 900 according to an exemplary embodiment of the present disclosure. Referring to FIG. 9, at a hardware level, the electronic device 900 includes a processor 902, an internal bus 904, a network interface 906, a memory 908, and a non-volatile memory 910. Apparently, hardware components needed by other services may also be included. The processor 902 reads a corresponding computer program from the non-volatile memory 910 into the memory 902 and then operates to form a network authentication apparatus 912 at a logical level. Apparently, in addition to software implementations, the present disclosure does not exclude other manners of implementation, such as a logic device or a combination of software and hardware, etc. In other words, an execution body of the following flow of processing is not limited to various logical units, and may be hardware or logic device(s).

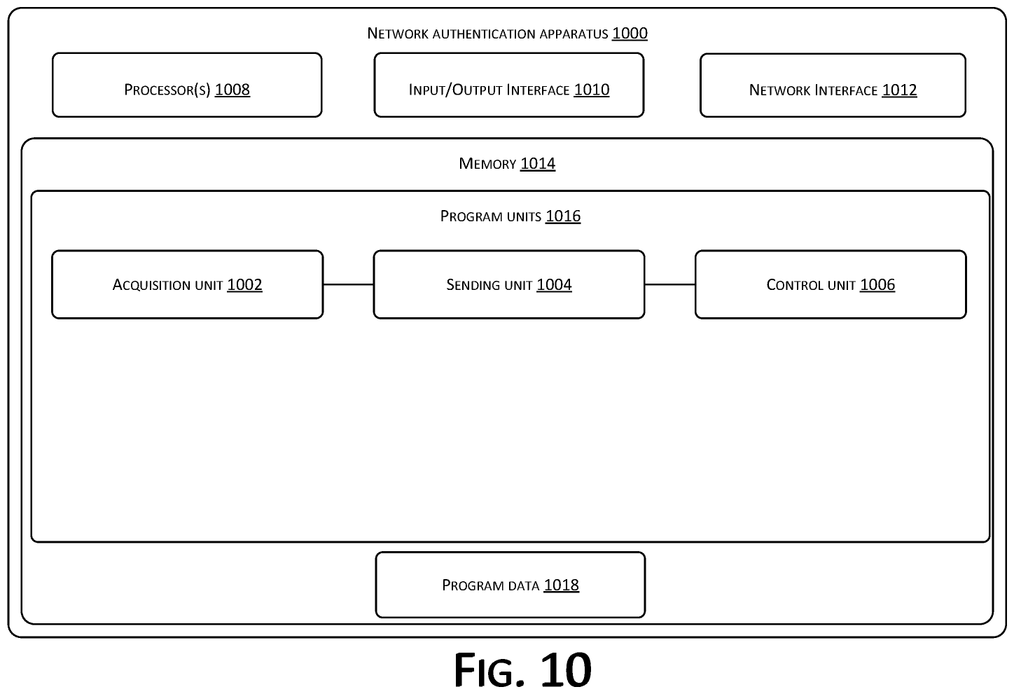

Referring to FIG. 10, in implementations, a network authentication apparatus 1000 may include an acquisition unit 1002, a sending unit 1004, and a control unit 1006.

The acquisition unit 1002 causes a network device client running on a network device that is bound to a preset group to obtain a unique device identifier of a user device in response to the network device detecting an access of the user device.

The sending unit 1004 causes the network device client to send an authentication request including the unique device identifier of the user device to a server of a preset mobile enterprise work platform, wherein the authentication request is used for instructing the server to perform authentication on the unique device identifier of the user device preset based on a pre-stored mapping relationship between identity information of associated users of the preset group and unique device identifiers, and a respective network access permission corresponding to each piece of identity information.

The control unit 1006 causes the network device client to receive an authentication result of the unique device identifier of the user device returned by the server, and control a network access operation of the user device according to the authentication result.

In implementations, the control unit 1006 is specifically configured to:

cause the network device client to control the network access operation according to a value of a permission option included in the authentication result, wherein the permission option includes at least one of the following: whether the permission exists, a valid period of the permission, and a number of remaining usages of the permission, and a network range allowed to access.

In implementations, the apparatus 1000 may further include one or more processors 1008, an input/output (I/O) interface 1010, a network interface 1012, and a memory 1014. The memory 1014 may include a form of computer readable media as described in the foregoing description.

In implementations, the memory 1014 may include program units 1016 and program data 1018. The program units 1016 may include one or more of the foregoing units as described above and as shown in FIG. 10.

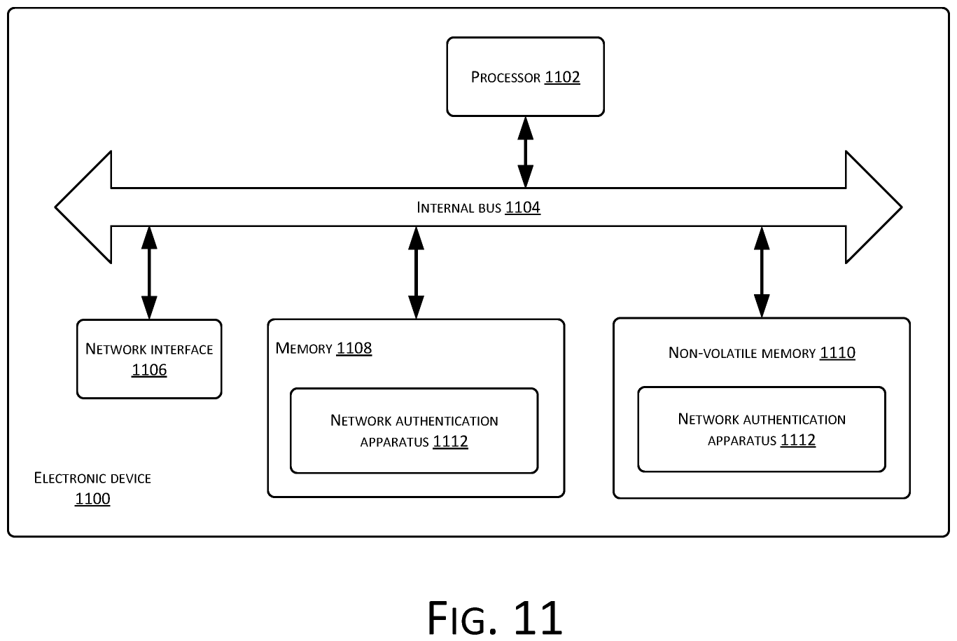

FIG. 11 shows a schematic structural diagram of an electronic device according to an exemplary embodiment of the present disclosure. Referring to FIG. 11, at a hardware level, the electronic device includes a processor 1102, an internal bus 1104, a network interface 1106, a memory 1108, and a non-volatile memory 1110. Apparently, hardware components needed by other services may also be included. The processor 1102 reads a corresponding computer program from the non-volatile memory 1110 into the memory 1102 and then operates to form a network authentication apparatus 1112 at a logical level. Apparently, in addition to software implementations, the present disclosure does not exclude other manners of implementation, such as a logic device or a combination of software and hardware, etc. In other words, an execution body of the following flow of processing is not limited to various logical units, and may be hardware or logic device(s).

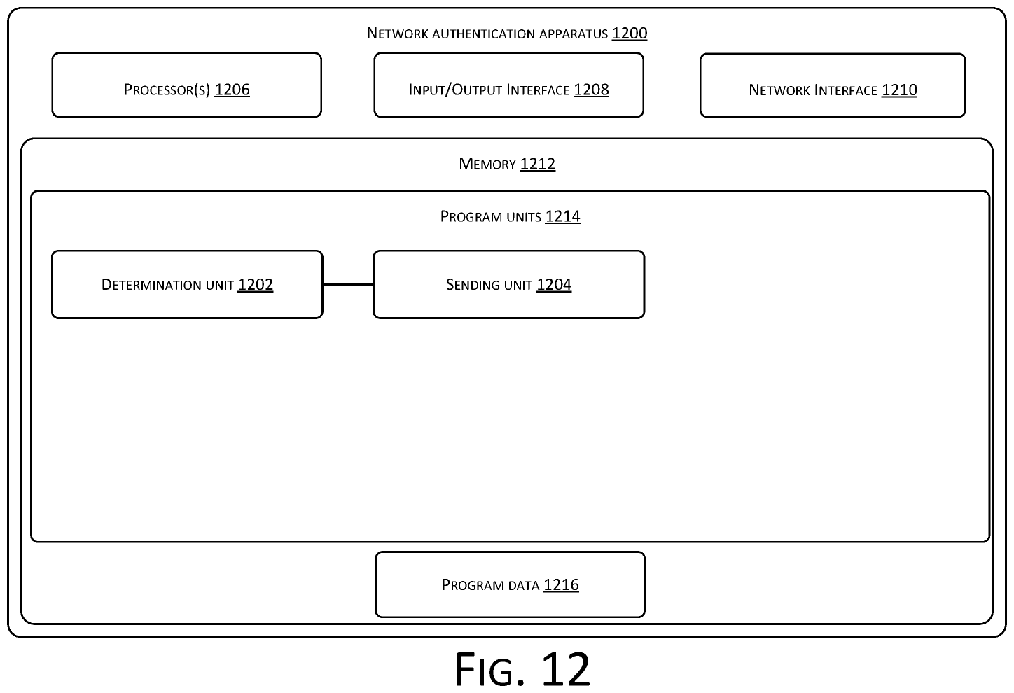

Referring to FIG. 12, in implementations, a network authentication apparatus 1200 may include a determination unit 1202 and a sending unit 1204.

The determination unit 1202 causes a user client of a preset mobile enterprise work platform running on an electronic device to determine identity information of a logged-in user.

The sending unit 1204 causes the user client to send a notification message to a server of the mobile enterprise work platform, wherein the notification message includes the identity information and a unique device identifier of the electronic device, to cause the server to record a mapping relationship between the identity information and the electronic device, wherein the mapping relationship is used for instructing the server to apply a network access permission of the identity information in a preset group to the electronic device to control the electronic device to implement a network access operation based on network device(s) under the preset group.

In implementations, the sending unit 1204 causes the user client to send the notification message to the server of the mobile enterprise work platform using at least one of the following ways:

sending the notification message when the user client detects a user login activity; and

sending the notification message when the user client detects an access instruction for any network device.

In implementations, the apparatus 1200 may further include one or more processors 1206, an input/output (I/O) interface 1208, a network interface 1210, and a memory 1212. The memory 1212 may include a form of computer readable media as described in the foregoing description.

In implementations, the memory 1212 may include program units 1214 and program data 1216. The program units 1214 may include one or more of the foregoing units as described above and as shown in FIG. 12.

The systems, apparatuses, modules or units illustrated in the foregoing embodiments may be implemented by a computer chip or an entity, or by a product having certain functions. A typical implementation device is a computer, and a specific form of the computer may be a personal computer, a laptop computer, a cellular phone, a camera phone, a smart phone, a personal digital assistant, a media player, a navigation device, an email transceiver, and a game control, a tablet, a tablet, a wearable device, or a combination of any of these devices.

In a typical configuration, a computer includes one or more processors (CPUs), an input/output interface, a network interface, and memory.

The memory may include a form of computer readable media such as a volatile memory, a random access memory (RAM) and/or a non-volatile memory, for example, a read-only memory (ROM) or a flash RAM. The memory is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

It also needs to be understood that terms “including”, “containing” or any other variations are intended to encompass a non-exclusive inclusion, such that a process, method, product, or device including a series of elements includes not only these elements, but also other elements that are not explicitly listed, or elements that are inherent to such process, method, product, or device. With any further limitation, an element defined by a phrase “comprising a . . . ” does not exclude the presence of additional equivalent elements in the process, method, product, or device including such element.

Exemplary embodiments are described in detail herein, examples of which are illustrated in the accompanying drawings. When accompanying drawings are involved in the following description, the same numerals in different drawings represent the same or similar elements unless indicated otherwise. The implementations described in the following exemplary embodiments do not represent all available embodiments that are consistent with the present disclosure. Rather, they are merely examples of apparatuses and methods that are consistent with some aspects of the present disclosure as described in detail in the appended claims.

Terminologies used in the present disclosure are merely intended to describe particular embodiments, and are not intended to be limiting. Singular forms “a”, “the” and “said” are intended to include a plural form, unless other meanings are clearly represented in the context. It should also be understood that a term “and/or” as used herein refers to and encompasses any and all possible combinations of one or more of associated items that are listed.

It should be understood that, although the present disclosure may use terms such as “first”, “second”, “third”, etc. to describe various types of information, these pieces of information should not be limited to these terms. These terms are only used for distinguishing information of a same type from each other. For example, first information may also be referred to as second information without departing from the scope of the present disclosure. Similarly, second information may also be referred to as first information. Depending on the context, a term “if” as used herein may be interpreted as “at the time of” or “when” or “in response to determining that”.

The above description is only exemplary embodiments of the present disclosure, and is not intended to limit the present disclosure. Any modifications, equivalent replacements, improvements, etc., that are made within the spirit and principles of the present disclosure, shall be included in the scope of protection of the present disclosure.

The present disclosure can be further understood using the following clauses.

Clause 1: A network authentication method comprising: receiving, by a server of a preset instant messaging application, an authentication request sent by a network device, the authentication request including a unique device identifier of a user device; determining, by the server, an authentication result of the unique device identifier of the user device, based on a preset group having a binding relationship with the network device, a mapping relationship between identity information of associated users of the preset group and unique device identifiers that is pre-recorded in the server, and a respective network access permission corresponding to each piece of identity information; and returning, by the server, the authentication result to the network device, to instruct the network device to control a network access operation of the user device according to the authentication result.

Clause 2: The method of Clause 1, further comprising: receiving, by the server, a notification message sent by an electronic device, the notification message including identity information that is logged in a user client of the instant messaging application running on the electronic device, and a unique device identifier of the electronic device; and recording, by the server, the identity information and the unique device identifier included in the notification message as a corresponding mapping relationship.

Clause 3: The method of Clause 1, further comprising: selecting, by the server, a most recently recorded mapping relationship for determining the authentication result corresponding to the unique device identifier of the user device when multiple mapping relationships corresponding to the unique device identifier of the user device exist.

Clause 4: The method of Clause 1, wherein the associated users comprise at least one of the following: an internal member of the preset group, an external contact of the preset group, and an external visitor of the preset group.

Clause 5: A network authentication method comprising: obtaining, by a network device client running on a network device that is bound to a preset group, a unique device identifier of a user device in response to the network device detecting an access of the user device; sending, by the network device client, an authentication request including the unique device identifier of the user device to a server of a preset instant messaging application, wherein the authentication request is used for instructing the server to perform authentication on the unique device identifier of the user device preset based on a pre-stored mapping relationship between identity information of associated users of the preset group and unique device identifiers, and a respective network access permission corresponding to each piece of identity information; and receiving, by the network device client, an authentication result of the unique device identifier of the user device returned by the server, and control a network access operation of the user device according to the authentication result.

Clause 6: The method of Clause 5, wherein controlling the network access operation of the user device according to the authentication result comprises: controlling, by the network device client, the network access operation according to a value of a permission option included in the authentication result, wherein the permission option includes at least one of the following: whether the permission exists, a valid period of the permission, and a number of remaining usages of the permission, and a network range allowed to access.

Clause 7: A network authentication method comprising: determining, by a user client of a preset instant messaging application running on an electronic device, identity information of a logged-in user; and sending, by the user client, a notification message to a server of the instant messaging application, wherein the notification message includes the identity information and a unique device identifier of the electronic device, to cause the server to record a mapping relationship between the identity information and the electronic device, wherein the mapping relationship is used for instructing the server to apply a network access permission of the identity information in a preset group to the electronic device to control the electronic device to implement a network access operation based on a network device under the preset group.

Clause 8: The method of Clause 7, wherein sending, by the user client, the notification message to the server of the instant messaging application comprises at least one of the following: sending the notification message when the user client detects a user login activity; and sending the notification message when the user client detects an access instruction for any network device.

Clause 9: A network authentication apparatus comprising: a request receiving unit that causes a server of a preset instant messaging application to receive an authentication request sent by a network device, the authentication request including a unique device identifier of a user device; an authentication unit that causes the server to determine an authentication result of the unique device identifier of the user device, based on a preset group having a binding relationship with the network device, a mapping relationship between identity information of associated users of the preset group and unique device identifiers that is pre-recorded in the server, and a respective network access permission corresponding to each piece of identity information; and a returning unit that causes the server to return the authentication result to the network device, to instruct the network device to control a network access operation of the user device according to the authentication result.

Clause 10: The apparatus of Clause 9, further comprising: a message receiving unit that causes the server to receive a notification message sent by an electronic device, the notification message including identity information that is logged in a user client of the instant messaging application running on the electronic device, and a unique device identifier of the electronic device; and a recording unit that causes the server to record the identity information and the unique device identifier included in the notification message as a corresponding mapping relationship.

Clause 11: The apparatus of Clause 9, further comprising: a selection unit that causes the server to select a most recently recorded mapping relationship for determining the authentication result corresponding to the unique device identifier of the user device when multiple mapping relationships corresponding to the unique device identifier of the user device exist.

Clause 12: The apparatus of Clause 9, wherein the associated users comprise at least one of the following: an internal member of the preset group, an external contact of the preset group, and an external visitor of the preset group.

Clause 13: A network authentication apparatus comprising: an acquisition unit that causes a network device client running on a network device that is bound to a preset group to obtain a unique device identifier of a user device in response to the network device detecting an access of the user device; a sending unit that causes the network device client to send an authentication request including the unique device identifier of the user device to a server of a preset instant messaging application, wherein the authentication request is used for instructing the server to perform authentication on the unique device identifier of the user device preset based on a pre-stored mapping relationship between identity information of associated users of the preset group and unique device identifiers, and a respective network access permission corresponding to each piece of identity information; and a control unit that causes the network device client to receive an authentication result of the unique device identifier of the user device returned by the server, and control a network access operation of the user device according to the authentication result.

Clause 14: The apparatus of Clause 13, wherein the control unit is specifically configured to: cause the network device client controlling the network access operation according to a value of a permission option included in the authentication result, wherein the permission option includes at least one of the following: whether the permission exists, a valid period of the permission, and a number of remaining usages of the permission, and a network range allowed to access.

Clause 15: A network authentication apparatus comprising: a determination unit that causes a user client of a preset instant messaging application running on an electronic device to determine identity information of a logged-in user; and a sending unit that causes the user client to send a notification message to a server of the instant messaging application, wherein the notification message includes the identity information and a unique device identifier of the electronic device, to cause the server to record a mapping relationship between the identity information and the electronic device, wherein the mapping relationship is used for instructing the server to apply a network access permission of the identity information in a preset group to the electronic device to control the electronic device to implement a network access operation based on network device(s) under the preset group.

Clause 16: The apparatus of Clause 15, wherein the sending unit causes the user client to send the notification message to the server of the instant messaging application using at least one of the following ways: sending the notification message when the user client detects a user login activity; and sending the notification message when the user client detects an access instruction for any network device.

What is claimed is:

1. A method comprising:
receiving, by a server of a preset instant messaging application, an authentication request sent by a network device, the authentication request including a unique device identifier of a user device;
determining, by the server, an authentication result of the unique device identifier of the user device; and
returning, by the server, the authentication result to the network device, to instruct the network device to control a network access operation of the user device according to the authentication result.

2. The method of claim 1, further comprising:
receiving, by the server, a notification message sent by an electronic device, the notification message including identity information that is logged in a user client of the instant messaging application running on the electronic device, and a unique device identifier of the electronic device; and
recording, by the server, the identity information and the unique device identifier included in the notification message as a corresponding mapping relationship.

3. The method of claim 1, wherein determining the authentication result of the unique device identifier of the user device comprises determining the authentication result of the unique device identifier of the user device based on a preset group having a binding relationship with the network device, a mapping relationship between identity information of associated users of the preset group and unique device identifiers that is pre-recorded in the server, and a respective network access permission corresponding to each piece of identity information.

4. The method of claim 3, further comprising:
selecting, by the server, a most recently recorded mapping relationship for determining the authentication result corresponding to the unique device identifier of the user device when multiple mapping relationships corresponding to the unique device identifier of the user device exist.

5. The method of claim 3, wherein the associated users comprise at least one of: an internal member of the preset group, an external contact of the preset group, and an external visitor of the preset group.

6. The method of claim 3, further comprising updating the mapping relationship in response to receiving a notification message from the user device, the notification message being received from the user device in response to a detection of a login activity of a user on the user device, or an access instruction to the network device from the user.

7. The method of claim 1, wherein the unique device identifier of the user device comprises a serial number of the user device, or a MAC address of the user device.

8. The method of claim 1, wherein the authentication result comprises one or more permission options.

9. The method of claim 8, wherein the one or more permission options comprise at least one of what the permission exists for the user device, a valid period of the permission, a number of remaining usages of the permission, and a network range that is allowed to access.

10. One or more computer readable media storing executable instructions that, when executed by a network device client, cause the network device client to perform acts comprising:
obtaining a unique device identifier of a user device in response to a network device detecting an access of the user device;
sending an authentication request including the unique device identifier of the user device to a server of a preset instant messaging application, wherein the authentication request is used for instructing the server to perform authentication on the unique device identifier of the user device preset based on a pre-stored mapping relationship between identity information of associated users of a preset group and unique device identifiers, and a respective network access permission corresponding to each piece of identity information; and
receiving an authentication result of the unique device identifier of the user device returned by the server, and controlling a network access operation of the user device according to the authentication result.

11. The one or more computer readable media of claim 10, wherein controlling the network access operation of the user device according to the authentication result comprises:
controlling the network access operation according to respective values of one or more permission options included in the authentication result.

12. The one or more computer readable media of claim 11, wherein the one or more permission options comprise at least one of: whether the permission exists for the user device, a valid period of the permission, and a number of remaining usages of the permission, and a network range allowed to access.

13. The one or more computer readable media of claim 12, wherein the network range allowed to access comprises one or more of an internal network of the preset group, a public network outside the preset group, a domestic range in the public network, and a foreign range in the public network.

14. The one or more computer readable media of claim 12, wherein the number of remaining usages of the permission is decremented by one after the user device accesses the network device and implements the network access operation once.

15. The one or more computer readable media of claim 10, wherein the network device client is run on the network device, and the network device is bound to the preset group.

16. The one or more computer readable media of claim 10, wherein the unique device identifier of the user device comprises a serial number of the user device, or a MAC address of the user device.

17. An electronic device comprising:
one or more processors;
memory;
a determination unit stored in the memory and executable by the one or more processors to cause a user client of a preset instant messaging application running on the electronic device to determine identity information of a logged-in user; and
a sending unit stored in the memory and executable by the one or more processors to cause the user client to send a notification message to a server of the instant messaging application, wherein the notification message includes the identity information and a unique device identifier of the electronic device, to cause the server to record a mapping relationship between the identity information and the electronic device, and wherein the mapping relationship is used for instructing the server to apply a network access permission of the identity information in a preset group to the electronic device to control the electronic device to implement a network access operation based on one or more network devices under the preset group.

18. The electronic device of claim 17, wherein the sending unit is further configured to cause the user client to send the notification message to the server of the instant messaging application when the user client detects a user login activity, or when the user client detects an access instruction for any network device.

19. The electronic device of claim 17, wherein the unique device identifier of the electronic device comprises a serial number of the electronic device, or a MAC address of the electronic device.

20. The electronic device of claim 17, wherein the electronic device is configured to scan and find the one or more network devices under the preset group through active scanning or passive scanning.
